(19) United States
(12) Patent Application Publication
(10) Pub. No.: US 2016/0344937 A1
(43) Pub. Date: Nov. 24, 2016

(54) IMAGE PROCESSING APPARATUS CAPABLE OF GENERATING IMAGE WITH DIFFERENT FOCAL POINT AFTER SHOOTING, CONTROL METHOD THEREFOR, AND STORAGE MEDIUM

(71) Applicant: CANON KABUSHIKI KAISHA, Tokyo (JP)

(72) Inventor: Koji Iwashita, Kawasaki-shi (JP)

(21) Appl. No.: 15/158,112

(22) Filed: May 18, 2016

(30) Foreign Application Priority Data
May 19, 2015 (JP) 2015-102004

(51) Int. Cl. H04N 5/232; H04N 5/372; H04N 5/378; H04N 5/265; G06K 9/00

(52) U.S. Cl. CPC H04N 5/23293; H04N 5/23212; H04N 5/265; H04N 5/23216; G06K 9/00228; G06K 9/00268; H04N 5/378; H04N 5/372

(57) ABSTRACT

An image processing apparatus which is capable of displaying OSD information on a subject in focus in an easily viewable manner. Based on an obtained image and information on the image, a focus-value changed image is generated by changing a focus value of the image. Subject information on subjects included in the image is stored in an EEPROM. Subject information corresponding to a subject brought into focus based on the changed focus value is superimposed on the focus-value changed image, and the focus-value changed image on which the subject information is superimposed is displayed on a panel display.

### BACKGROUND OF THE INVENTION

Field of the Invention

The present invention relates to an image processing apparatus, a control method therefor, and a storage medium, and in particular to an image processing apparatus and a control method therefor which are capable of generating an image with a different focal point after shooting, as well as a storage medium.

Description of the Related Art

Lately, a light-field camera is known as an image processing apparatus capable of performing image processing based on a variety of information stored at the time of shooting and generating an image with a different focal point. The light-field camera has a micro-lens array including a plurality of micro-lenses and stores information on the intensity distribution of light, which passes through the micro-lenses and is received by an image pickup device at the time of shooting, and information on the travelling directions of the light. Based on the information on the intensity distribution of the light and the information on the travelling directions of the light thus stored, the light-field camera is able to perform image processing on, for example, an image with a certain subject focused (hereafter referred to as “in focus”) to generate an image in which another subject is in focus.

The light-field camera is capable of displaying a variety of images on a display unit or the like provided in the light-field camera and has an OSD function of displaying information on a subject included in an image when displaying this image on the display unit. In the light-field camera, a subject corresponding to setting information set in advance is detected among subjects included an image that is displayed (hereafter referred to as a “displayed image”). Also, in the light-field camera, a name or the like of the detected subject is superimposed on the displayed image as information displayed by the OSD function (hereafter referred to as “OSD information”), and an image obtained as a result of superimposition (hereafter referred to as a “superimposed image”) is displayed. On the display unit, even when multiple pieces of OSD information are displayed, those pieces of USE information are displayed in an area including no subject and an area including a subject out of focus so as to prevent a displayed image from becoming difficult to see (see, for example, Japanese Laid-Open Patent Publication (Kokai) No. 2012-234022). In a superimposed image, OSD information corresponding to a subject in focus among detected subjects is superimposed.

In a superimposed image, however, OSD information undesired by a user may be superimposed on a displayed image. For example, when image processing is performed on a displayed image to generate another displayed image with a different focal point, and a subject corresponding to the OSD information is brought out of focus due to the image processing, the OSD information on this subject may be displayed as it is. In this case, OSD information corresponding to a subject in focus and OSD information corresponding to a subject out of focus are mixed in the displayed image, and as a result, the OSD information on the subject in focus is difficult to see.

### SUMMARY OF THE INVENTION

The present invention provides an image processing apparatus and a control method therefor, which are capable of displaying OSD information on a subject in focus in an easily viewable manner, as well as a storage medium.

Accordingly, the present invention provides an image processing apparatus comprising a processor and a memory storing a program which, when executed by the processor, causes the image processing apparatus to: generate a focus-value changed image by changing a focus value of the image based on an obtained image and information on the image; store subject information on subjects included in the image; and superimpose, on the focus-value changed image, the subject information corresponding to a subject brought into focus based on the changed focus value and display the focus-value changed image on which the subject information is superimposed.

According to the present invention, OSD information on a subject in focus is displayed in such a way as to be easily viewable.

Further features of the present invention will become apparent from the following description of exemplary embodiments with reference to the attached drawings).

### BRIEF DESCRIPTION OF THE DRAWINGS

FIG. 1 is a block diagram schematically showing an arrangement of a light-field camera according to an embodiment of the present invention.

FIG. 2 is a view useful in explaining arrangements of a micro-lens array and a CCD in FIG. 1.

FIG. 3 is a view useful in explaining how light-receiving elements in FIG. 2 receive light.

FIGS. 4A and 4B are views useful in explaining an exit pupil and light-receiving element groups in FIG. 3, FIG. 4A showing split areas of the exit pupil, and FIG. 4B showing a light-receiving element group corresponding to a micro-lens.

FIG. 5 is a flowchart showing the procedure of a light-field data generation process which is carried out by the light-field camera in FIG. 1.

FIG. 6 is a flowchart showing the procedure of an OSD information display process which is carried out by the light-field camera in FIG. 1.

FIG. 7 is a view showing exemplary reduced images displayed on a panel display in FIG. 1.

FIGS. 8A to 8C are views useful in explaining superimposed images displayed on the panel display in FIG. 1, FIG. 8A showing a superimposed image in which subject information on a subject 801 is superimposed, FIG. 8B showing a superimposed image in which subject information on a subject 802 is superimposed, and FIG. 8C showing a superimposed image in which subject information on subjects 801 to 803 is superimposed.

FIG. 9 is a flowchart showing the procedure of a variation of the OSD information display process in FIG. 6.

FIGS. 10A to 10D are views useful in explaining a variety of images displayed on the panel display in FIG. 1, FIG. 10A showing a superimposed image in which subject information on a subject 1002 is superimposed, FIG. 10B showing a superimposed image in which subject information on subjects 1003 and 1004 is superimposed, FIG. 10C showing a selection menu, and FIG. 10D showing a superimposed image in which subject information on a subject 1004 is superimposed.

### DESCRIPTION OF THE EMBODIMENTS

Hereafter, an embodiment of the present invention will be described in detail with reference to the drawings.

In the present embodiment described hereafter, the present invention is applied to a light-field camera which is an image processing apparatus, but the present invention should not necessarily be applied to a light-field camera but may be applied to any image processing apparatuses as long as they are capable of generating an image with a different focal point after shooting.

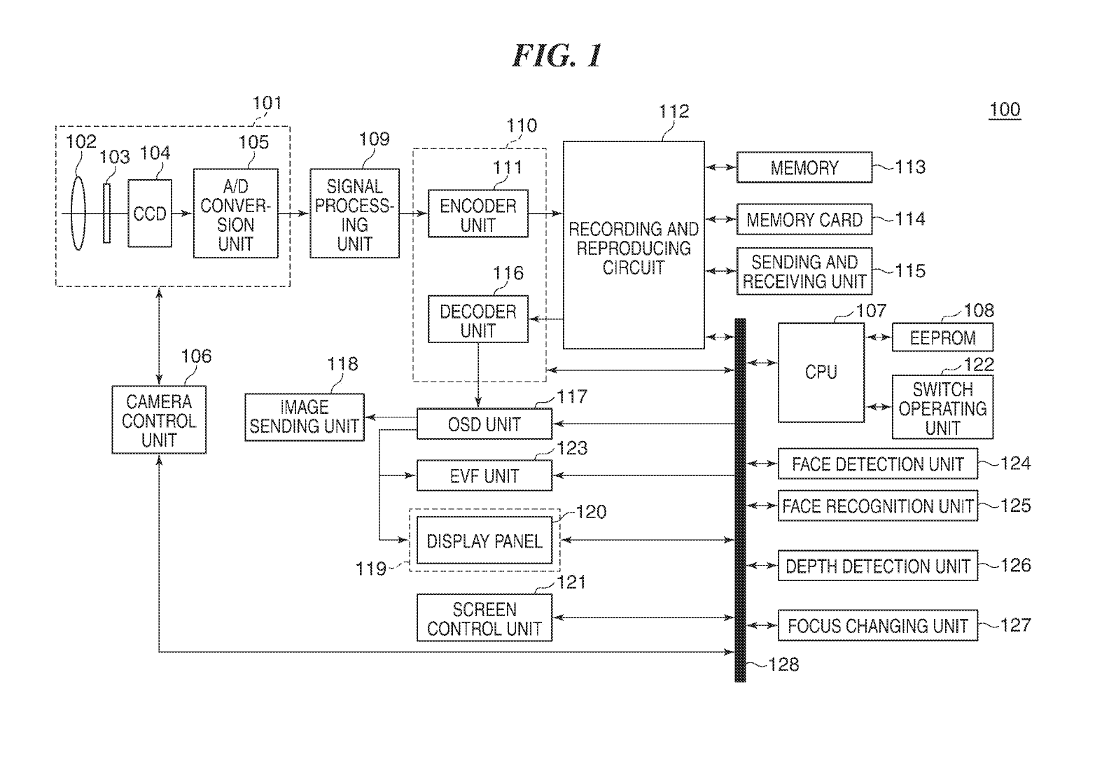

FIG. 1 is a block diagram schematically showing an arrangement of the light-field camera 100 according to the embodiment of the present invention.

Referring to FIG. 1, the light-field camera 100 has an image pickup unit 101, a camera control unit 106, a CPU 107, an EEPROM 108, a signal processing unit 109, a data conversion unit 110, a recording and reproducing circuit 112, a memory 113, and a memory card 114. The light-field camera 100 also has a sending and receiving unit 115, an OSD unit 117, an image sending unit 118, a touch panel operating unit 119, a screen control unit 121, a switch operating unit 122, and an electronic viewfinder (EVF) unit 123. Further, the light-field camera 100 has a face detection unit 124, a face recognition unit 125, a depth detection unit 126, and a focus changing unit 127. The CPU 107 is connected to the camera control unit 106, the data conversion unit 110, the recording and reproducing circuit 112, the OSD unit 117, the touch panel operating unit 119, the screen control unit 121, and the EVF unit 123 via a system bus 128. The CPU 107 is also connected to the face detection unit 124, the face recognition unit 125, the depth detection unit 126, and the focus changing unit. 127 via the system bus 128. Further, the CPU 107 is connected to the EERPOM 108 and the switch operating unit 122. The image pickup unit 101 is connected to the camera control unit 106 and the signal processing unit 109, the signal processing unit 109 is connected to the data conversion unit 110, and the data conversion unit 110 is connected to the recording and reproducing circuit 112 and the OSD unit. 117. The recording and reproducing circuit 112 is connected to the memory 113, the memory card 114, and the sending and receiving unit 115, and the OSD unit 117 is connected to the image sending unit 118, the touch panel operating unit. 119, and the EVF unit 123. The image pickup unit 101 has a lens unit 102, a micro-lens array 103, a CCD 104, and an A/D processing unit 105, the data conversion unit 110 has an encoder unit 111 and a decoder unit 116, and the touch panel operating unit 119 has a panel display 120.

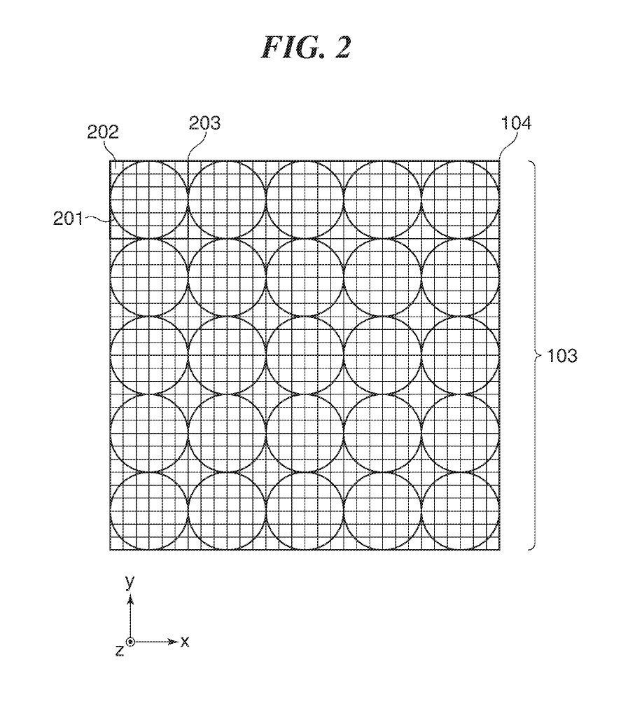

The light-field camera 100 has a refocusing function of, based on an image obtained by shooting and a variety of information stored at the time of shooting, generating an image with a different focal point. The image pickup unit 101 is for taking an image of a subject. The lens unit 102 has a variety of lenses, not shown, such as a fixed lens group and a variable magnification lens group for gathering light, a diaphragm, and a correction lens group, and has a function of correcting an image-forming position and a function of adjusting focus. A plurality of micro-lenses 201 in FIG. 2, to be described later, is arranged in the micro-lens array 103. The CCD 104, which is an image pickup device, receives bundles of rays that have passed through the lens unit 102 and the micro-lens array 103 and photoelectrically converts the received bundles of rays to generate an image pickup signal. The A/D processing unit. 105 converts the image pickup signal generated by the CCD 104 into a digital signal to generate an image signal. The camera control unit 106 controls the image pickup unit 101 based on control signals sent from the CPU 107. The camera control unit 106 also obtains a variety of information on the image pickup unit 101 such as focusing information and camera shake information from the image pickup unit 101 and sends the obtained information on the image pickup unit 101 to the CPU 107. The CPU 107 has a ROM, a RAM, a timer, and so forth, not shown, and centrally controls the overall system of the light-field camera 100. The CPU 107 stores control programs for carrying out various types of processing in the ROM, uses the RAM as a work area, and uses the timer to measure, for example, time periods over which various types of processing are performed. The EEPROM 108 stores a variety of data that is used by the CPU 107. In the present embodiment, the EEPROM 108 stores subject information including, for example, subject names of respective subjects.

The signal processing unit 109 generates picked-up image data based on an image signal generated by the A/D processing unit 105. The encoder unit 111 has a light-field encoder and a JPEG encoder, not shown, and carries out a process to generate light-field data for generating an image with a different focal point, and a JPEG compression process based on control signals sent from the CPU 107. The light-field encoder encodes a variety of images such as picked-up image data generated by the signal processing unit 109 into light-field data. The light-field data includes a focus value which is a setting value relating to a focal point of an image. The JPEG encoder generates an image on a focus plane derived based on light-field data. In the present embodiment, the JPEG encoder is able to generate a refocused image (focus-value changed image) which is an image with a different focus value from that of an image obtained by shooting. The recording and reproducing circuit 112 has a direct memory access (DMA) function and enables data communications between the memory 113 and the memory card 114 and the data conversion unit 110. In the present embodiment, in response to an instruction to generate light-field data, the recording and reproducing circuit 112 automatically transfers a variety of data stored in the memory 113 or the memory card 114 to the data conversion unit 110. The recording and reproducing circuit 112 also carries out data communications with the sending and receiving unit 115. The memory 113 temporarily stores light-field data obtained as a result of encoding by the encoder unit 111. The memory card 114 stores image data and moving image data obtained by shooting. The decoder unit 116 has a light-field decoder and a JPEG decoder, not shown. In response to a desired focus value being set by the CPU 107, the light-field decoder decodes a refocused image based on the set focus value. The JPEG decoder reads out compressed JPEG data from the memory 113 based on address information set by the CPU 107 and converts the read-out compressed JPEG data into a digital video signal such as ITU-R BT.656 (CCIR656).

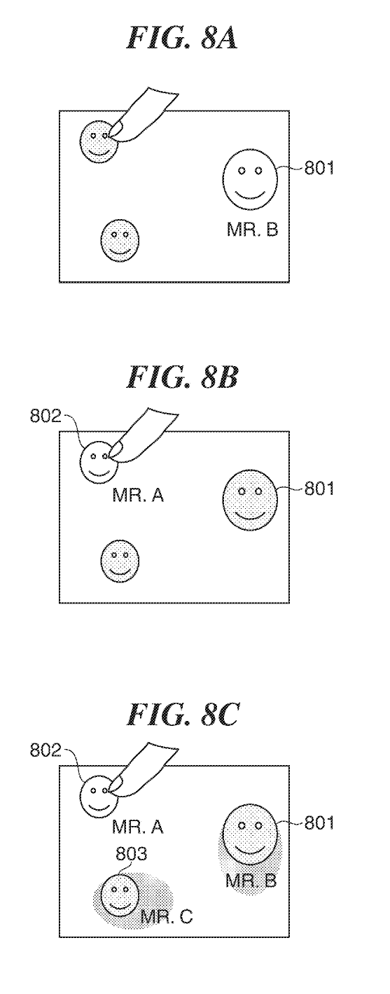

The CSD unit 117 superimposes a variety of OSD information. For example, the OSD unit 117 superimposes subject information, which corresponds to subjects included in a refocused image, as OSD information. The image sending unit 118 sends a digital video signal obtained as a result of conversion by the decoder unit 116 to an external apparatus such as a television receiver. A variety of operating buttons and a variety of images are displayed on the panel display 120 which the touch panel operating unit 119 has, and for example, a superimposed image in which subject information corresponding to subjects is superimposed is displayed as shown in FIGS. 8A to 8C.

The screen control unit 121 carries out data communications with the touch panel operating unit 119 to obtain input information input on the touch panel operating unit 119. The screen control unit 121 also controls display of various images displayed on the panel display 120. The switch operating unit 122 has a variety of operating keys, not shown. A user makes various settings by operating the touch panel operating unit 119 and the switch operating unit 122. In the present embodiment, for example, through user's operations on the touch panel operating unit 119 and the switch operating unit 122, a “shooting mode” for taking a still image or the like and a “reproducing mode” for reproducing an image obtained by shooting are set. The EVF unit 123 is used as a small window through which a subject is peeped. The face detection unit 124 subjects image data to a face detection process to detect a face region of a person included in the image data. For example, the face detection unit 124 extracts characteristic points such as end points of eyes, nose, and mouth and contour points of a face from image data, and based on the extracted characteristic points, detects a face region and a face size of a subject. The face recognition unit 125 generates face authentication data indicating characteristics of a face, which is an object to be authenticated, based on a detection result obtained by the face detection unit 124. For example, the face recognition unit 125 generates face authentication data based on positions of characteristic points in a detected face, sizes of facial parts derived from the characteristic points, relative distances among the characteristic points, and so forth. In the present embodiment, generated face authentication data and subject information are associated with each other and stored in the EEPROM 108. For example, when a subject that corresponds, for example, matches face authentication data is detected from a refocused image displayed on the panel display 120, subject information corresponding to the detected subject is superimposed as OSD information on the subject. The depth detection unit 126 detects information on a distance from the light-field camera 100 to a subject. The focus changing unit 127 sets a focus value for generating a refocused image. It should be noted that an object to be detected by the face detection process should not necessarily be a face but may also be another specific subject. In this case, the face detection unit 124 may carry out a subject detection process in the same way as the face detection process.

FIG. 2 is a view useful in explaining arrangements of the micro-lens array 103 and the COD 104 in FIG. 1.

Referring to FIG. 2, the micro-lens array 103 has a plurality of micro-lenses 201 and is disposed at a location opposed to the COD 104 with a predetermined clearance left therebetween. In FIG. 2, a Z-axis indicates an optical axis, an X-axis indicates a horizontal direction as the light-field camera 100 is seen from front in a direction of an optical axis, and a Y-axis indicates a direction perpendicular to the horizontal direction. In the micro-lens array 103, a plurality of e.g. five micro-lenses 201 are arranged at regular intervals along each of the X-axis and the Y-axis. It should be noted that in the present embodiment, the number of micro-lenses 201 placed along each of the X-axis and the Y-axis in the micro-lens array 103 is five by way of example, but the number of micro-lenses 201 provided in the micro-lens array 103 is not limited to this.

Referring to FIG. 2, the CUD 104 has a plurality of light-receiving elements 202 arranged in a grid pattern. Light-receiving element groups 203 each including a predetermined number of light-receiving elements 202 are associated with the respective micro-lenses 201, and in FIG. 2, it is assumed that, for example, 6×6=36 light-receiving elements 202 are included in each of the light-receiving element groups 203. Bundles of rays that have passed through each micro-lens 201 are separated according to directions in which they are incident on the micro-lens 201 and fall upon light-receiving elements 202 included in a light-receiving element group 203 associated with the micro-lens 201.

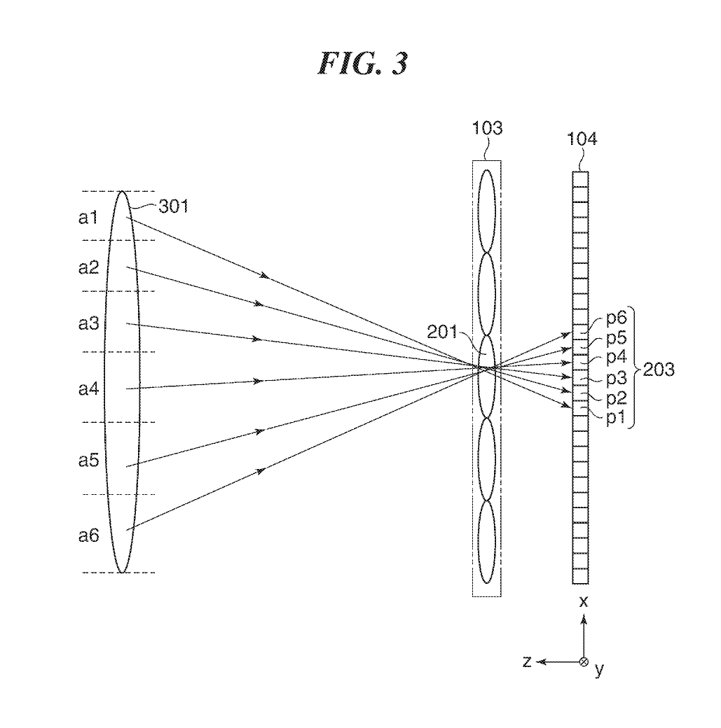

FIG. 3 is a view useful in explaining how the light-receiving elements 202 in FIG. 2 receive light.

FIG. 3 shows an exit pupil 301, which represents the lens unit 102 when the light-field camera 100 is seen along the Y-axis, the micro-lens array 103, and the rap 104. FIG. 3 shows a state where, for example, bundles of rays that have passed through a certain micro-lenses 201 placed in the micro-lens array 103 fall upon light-receiving elements p1 to p6. It should be noted that in FIG. 3 as well, a Z-axis indicates an optical axis, an X-axis indicates a horizontal direction as the light-field camera 100 is seen from front in a direction of the optical axis, and a Y-axis indicates a direction perpendicular to the horizontal direction.

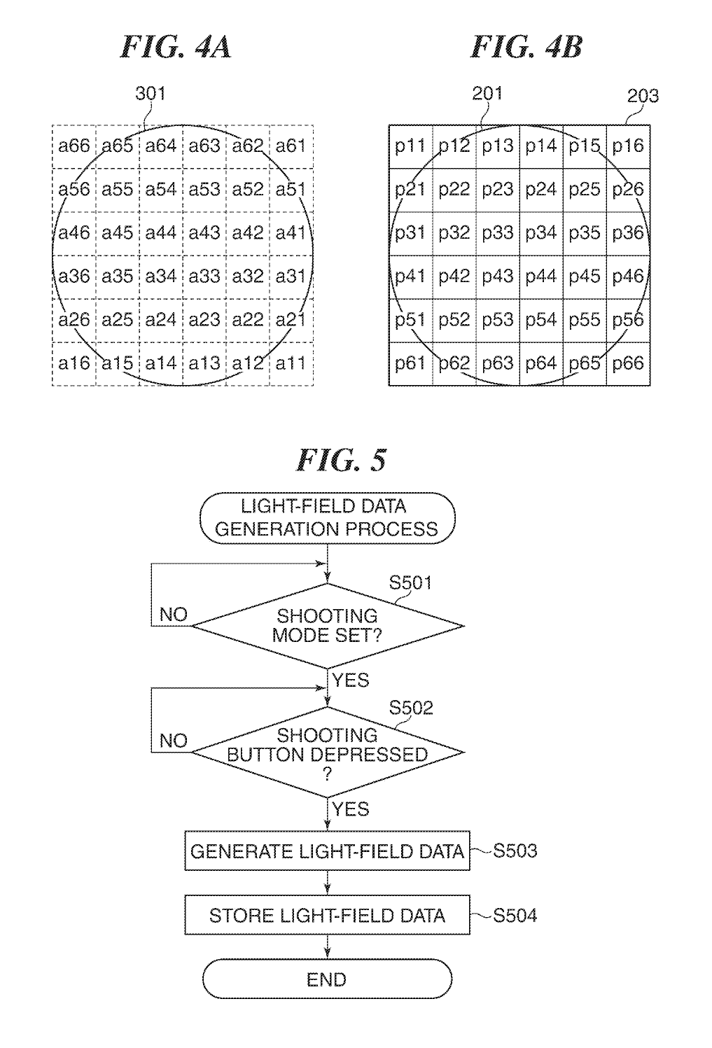

Referring to FIG. 3, bundles of rays that have passed through respective split areas a1 to a6 obtained by dividing the exit pupil 301 into six in a direction of the X-axis pass through the micro-lens 201. The bundles of rays that have passed through the micro-lens 201 fall upon the respective light-receiving elements p1 to p6 included in a light-receiving element group 203 associated with the micro-lens 201. For example, a bundle of rays that has passed through the split area al falls upon the light-receiving element p1, a bundle of rays that has passed through the split area a2 falls upon the light-receiving element p2, and a bundle of rays that has passed through the split area a3 falls upon the light receiving element p3. A bundle of rays that has passed through the split area a4 falls upon the light-receiving element p4, a bundle of rays that has passed through the split area a5 falls upon the light-receiving element p5, and a bundle of rays that has passed through the split, area a6 falls upon the light-receiving element p6. It should be noted that in FIG. 3, bundles of rays pass through split areas obtained by dividing the exit pupil 301 into six in the direction of the X-axis, but the split areas should not necessarily be in the direction of the X-axis but may be in the direction of the Y-axis as well. Specifically, the exit pupil 301 as the lens unit 102 is seen from front is divided into split areas a11 to a66 as shown in FIG. 4A. Bundles of rays that have passed through the respective split regions a11 to a66 pass through the micro-lens 201, and as shown in FIG. 4B, fall upon light-receiving elements p11 to p66 included in a light-receiving element group 203 associated with the micro-lens 201. It should be noted that in another micro-lens 201 placed in the micro-lens array 103 as well, bundles of rays that have passed through this micro-lens 201 fall upon light-receiving elements p11 to p66 included in a light-receiving element group 203 associated with this micro-lens 201. Based on the bundles of rays received by the respective light-receiving elements p11 to p66, light-field data for use in, for example, generating a refocused image is generated.

FIG. 5 is a flowchart showing the procedure of a light-field data generation process which is carried out by the light-field camera 100 in FIG. 1.

The process in FIG. 5 is carried out by the CPU 107 executing a variety of control programs stored in the ROM of the CPU 107.

Referring to FIG. 5, first, the CPU 107 determines whether or not the shooting mode has been set through operation on the touch panel operating unit 119 or the switch operating unit 122 by the user (step S501). Upon determining that the shooting mode has been set (YES in the step S501), the CPU 107 determines whether or not a shooting button for starting shooting has been depressed on the touch panel operating unit 119 or the switch operating unit 122 (step S502). Upon determining that the shooting button has been depressed. (YES in the step S502), the CPU 107 generates light-field data (step S503). Next, the CPU 107 stores the generated light-field data in the memory 113 (step S504) and terminates the present process.

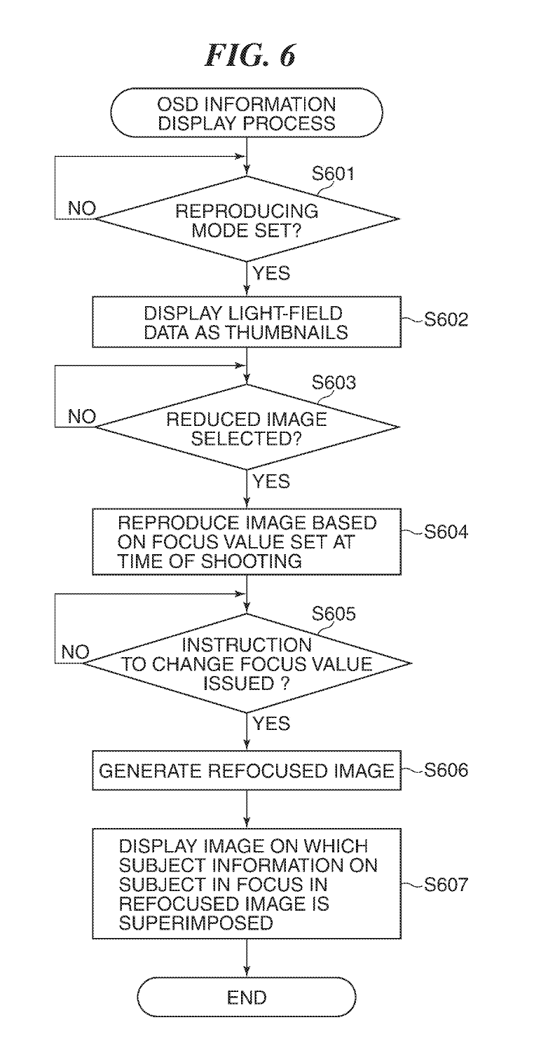

FIG. 6 is a flowchart showing the procedure of an USE) information display process which is carried out by the light-field camera 100 in FIG. 1.

For example, when a refocused image is generated by performing image processing, and a subject corresponding to subject information superimposed as OSD information is brought out of focus due to the image processing, the subject information corresponding to this subject may be displayed as it is. In this case, subject information corresponding to a focused subject and the subject information on the subject out of focus are mixed in a superimposed image, and as a result, the subject information corresponding to the focused subject is not easily viewable.

Accordingly, in the present embodiment, a superimposed image in which only subject information corresponding to a subject in focus in a refocused image is superimposed is displayed.

The process in FIG. 6 is carried out by the CPU 107 executing a variety of control programs stored in the ROM of the CPU 107, and it is assumed that as OSD information on an image displayed on the panel display 120, subject information corresponding to a subject included in the image is superimposed.

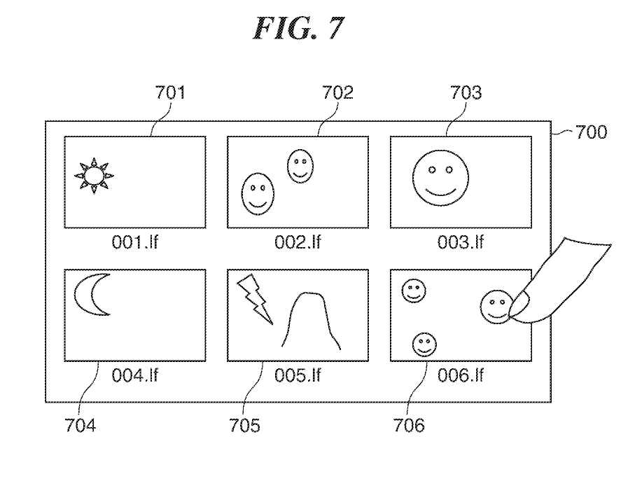

Referring to FIG. 6, first, the CPU 107 determines whether or not the reproducing mode has been set through operation on the touch panel operating unit 119 or the switch operating unit 122 by the user (step S601). Upon determining that the reproducing mode has been set (YES in the step S601), the CPU 107 displays light-field data, which is stored in the memory card 114, as thumbnails (step S602). Specifically, the CPU 107 displays reduced images 701 to 706 in FIG. 7, which correspond to respective pieces of light-field data, on the panel display 120. As shown in FIG. 7, an extension “.1f”, which indicates data is light-field data, is added to file names identifying the respective reduced images 701 to 706. The CPU 107 reads out light-field data from the memory 113, causes the decoder unit 116 to decode images based on a focus values set at the time of shooting, and displays, on the panel display 120, the reduced images 701 to 706 obtained by reducing the decoded images. The CPU 107 then determines whether or not any one of the reduced images 701 to 706 displayed on the panel display 120 has been selected by the user (step S603). Upon determining that, for example, the reduced image 706 has been selected (YES in the step S603), the CPU 107 reproduces an image corresponding to the reduced image 706, that is, an image based on a focus value set at the time of shooting (step S604). After that, the CPU 107 displays a superimposed image in which subject information corresponding to a subject in focus among subjects included in the reproduced image is superimposed. Specifically, as shown in FIG. 8A, a superimposed image in which “Mr. B” indicating a name of a subject 801 in focus is superimposed is displayed. Then, the CPU 107 determines whether or not an instruction to change the focus value has been issued through operation on the touch panel operating unit 119 by the user (step S605). In the present embodiment, for example, when the user has touched any one of a plurality of subjects displayed on the panel display 120, the CPU 107 determines that an instruction to change the focus value has been issued. On the other hand, when the user has touched none of a plurality of subjects displayed on the panel display 120, the CPU 107 determines that an instruction to change the focus value has not been issued. Upon determining that the user has issued an instruction to change the focus value by touching, for example, a subject 802 as shown in FIG. 8B (YES in the step S605), the CPU 107 generates a refocused image in which the subject 802 is in focus (step S606) (image generation unit). The CPU 107 then carries out a face detection process on the generated refocused image and obtains subject information corresponding to a detected face region. Further, the CPU 107 displays a superimposed image in which only “Mr. A”, which is subject information corresponding to the subject 802 in focus, is superimposed (step S607) and terminates the present process. Here, the face detection process may be carried out only a focal plane, or the face detection process may be carried out on all the planes, and among subject information obtained from all the planes, only subject information obtained from the focal plane may be displayed in a superimposed manner.

According to the process in FIG. 6, a superimposed image in which only “Mr. A”, which is subject information corresponding to the subject 802 in focus in the refocused image is superimposed, is displayed. As a result, unnecessary subject information on subjects other than the subject 802 in focus is not displayed in the superimposed image, and hence the subject information on the subject 802 in focus is displayed in an easily viewable manner.

It should be noted that a superimposed image in which subject information on subjects with transmittances differing according to focusing levels of the subjects is superimposed may be displayed. Specifically, as shown in FIG. 8C, when the subject 802 is in focus, and subjects 801 and 803 are out of focus, the CPU 107 obtains subject information corresponding to the subjects 801 to 803. After that, the CPU 107 sets the transmittance of subject information corresponding to the subject 802 in focus (for example, “Mr. A”) to zero. Further, the CPU 107 sets the transmittance of subject information corresponding to the subjects 801 and 803, out of focus (for example, “Mr. R” or “Mr. C”), to half and displays a superimposed image in which the subject information with the set transmittances is superimposed. Thus, subject information on a subject in focus (for example, “Mr. A”) and subject information on a subject out of focus (for example, “Mr. B” and “Mr. C”) are easily distinguished from each other based on transmittances. As a result, subject information on a subject in focus is displayed in a more easily viewable manner.

According to the process in FIG. 6, when a plurality of subjects in focus is included in a refocused image, desired subject information may be selected from subject information on the plurality of subjects in focus by the user.

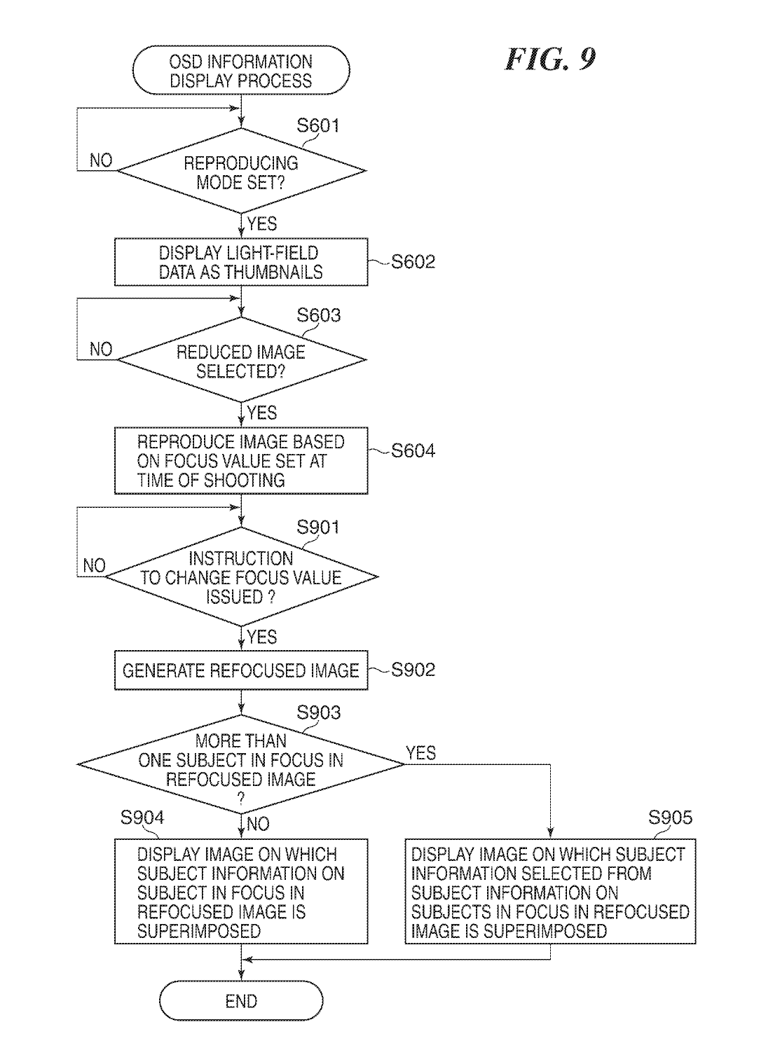

FIG. 9 is a flowchart showing the procedure of a variation of the OSD information display process in FIG. 6.

The process in FIG. 9 as well is carried out by the CPU 107 executing a variety of control programs stored in the ROM of the CPU 107, and it is assumed that as OSD information on an image displayed on the panel display 120, subject information corresponding to a subject included in the image is superimposed.

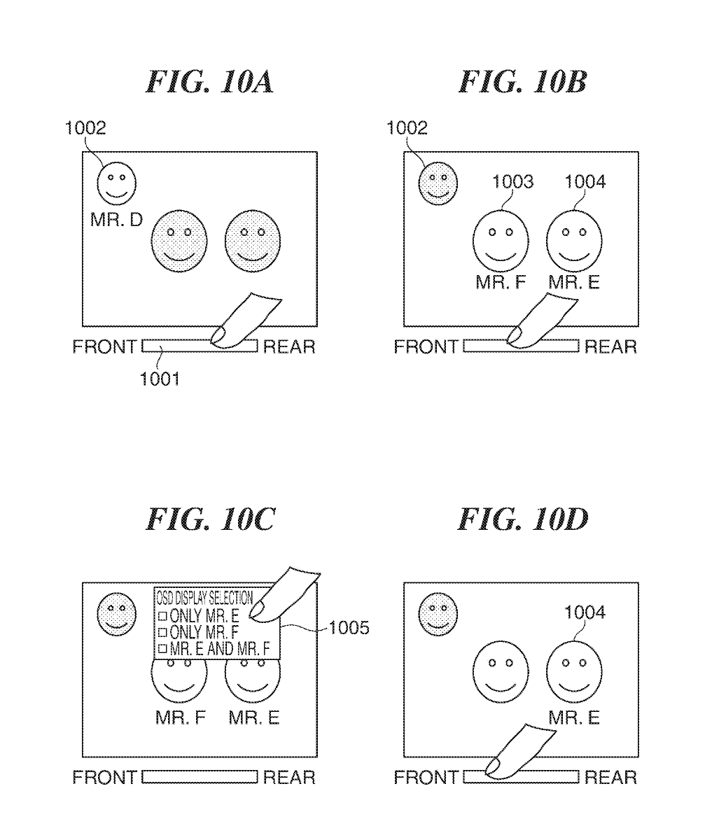

Referring to FIG. 9, first, the CPU 107 carries out the same processes as those in the steps S601 to S604 in FIG. 6. Next, the CPU 107 determines whether or not an instruction to change the focus value has been issued through operation on the touch panel operating unit 119 by the user (step S901). In the step S901, when the user has operated a slide bar 1001 in FIG. 10A, which is displayed on the panel display 120 and for use in setting a focus value, the CPU 107 determines that an instruction to change the focus value has been issued. On the other hand, when the user has not operated the slide bar 1001 displayed on the panel display 120, the CPU 107 determines that an instruction to change the focus value has not been issued. Focus values are allowed to be set stepwise with the slide bar 1001, and focus values are set so that as a touched position comes closer to “the front”, a subject closer to the light-field camera 100 can be brought into focus. Also, focus values are set so that as a touched position comes closer to “the rear”, a subject farther from the light-field camera 100 can be brought into focus. Upon determining that an instruction to change the focus value to such a focus value as to bring subjects 1003 and 1004 into focus has been issued (YES in the step S901), the CPU 107 generates a refocused image in which subjects 1003 and 1004 are in focus (step S902). The CPU 107 then carries out a face detection process on the refocused image and determines whether or not more than one subject is in focus (steps S903).

As a result of the determination in the step S903, when only one subject is in focus, for example, only a subject 1002 is in focus according to subject information obtained by carrying out the face detection process, the CPU 107 superimposes only “Mr. D” that is subject information on the subject 1002. After that, the CPU 107 displays a resultant superimposed image on the panel display 120 (step S904) and terminates the present process.

On the other hand, as a result of the determination in the step S903, when more than one subject is in focus, the CPU 107 displays a selection menu 1005 which allows selection of subject information to be superimposed as OSD information from among multiple pieces of subject information obtained by carrying out the face detection process. For example, when the subjects 1003 and 1004 are in focus in a refocused image, “only Mr. E” for displaying only Mr. E that is subject information on the subject 1004 is indicated in the selection menu 1005. Also, in the selection menu 1005, “only Mr. F” for displaying only Mr. F that is subject information on the subject 1003, and “Mr. E and Mr. F” for displaying both Mr. E and Mr. F are indicated. The CPU 107 then displays, on the panel display 120, a superimposed image in which only subject information based on a selection made from the selection menu 1005 by the user (hereafter referred to as “selected subject information”) is superimposed (step S905). For example, when the user selects “only Mr. F” from the selection menu 1005, a superimposed image in which only Mr. E is superimposed is displayed on the panel display 120 as shown in FIG. 10D. The CPU 107 then carries out the process in the step S905 and terminates the present process.

According to the process in FIG. 9, when a plurality of subjects 1003 and 1004 in focus is included in a refocused image, desired subject information is selected from the subject information on the subjects 1003 and 1004 (for example, “Mr. F” and “Mr. F”) by the user. Therefore, only subject information desired by the user is selected and displayed, and this enhances convenience for the user.

### Other Embodiments

Embodiment (s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit. (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-102004, filed May 19, 2015 which is hereby incorporated by reference wherein in its entirety.

What is claimed is:

1. An image processing apparatus comprising:
a processor; and
a memory storing a program which, when executed by the processor, causes the image processing apparatus to:
generate a focus-value changed image by changing a focus value of the image based on an obtained image and information on the image;
store subject information on subjects included in the image; and
superimpose, on the focus-value changed image, the subject information corresponding to a subject brought into focus based on the changed focus value and display the focus-value changed image on which the subject information is superimposed.

2. The image processing apparatus according to claim 1, wherein the subject information is displayed, on the focus-value changed image, with different transparency according to focusing levels of the subjects corresponding to the subject information.

3. The image processing apparatus according to claim 1, further causes the image processing apparatus to, when a plurality of subjects in focus is included in a focus-value changed image, enable a user to select subject information on a desired subject in focus from subject information on the plurality of subjects in focus.

4. The image processing apparatus according to claim 1, further causes the image processing apparatus to carry out a subject detection process on a subject brought into focus based on the changed focus value and obtain subject information on the subject.

5. The image processing apparatus according to claim 1, further causes the image processing apparatus to carry out a subject detection process on subjects included in the image and obtain subject information on a subject brought into focus based on the changed focus value.

6. A displaying method for displaying images, comprising:
generating a focus-value changed image by changing a focus value of the image based on an obtained image and information on the image;
storing subject information on subjects included in the image; and
superimposing, on the focus-value changed image, the subject information corresponding to a subject brought into focus based on the changed focus value and displaying the focus-value changed image on which the subject information is superimposed.

7. A non-transitory computer-readable storage medium storing a program for causing a computer to execute a displaying method for displaying images, the display method comprising:
generating a focus-value changed image by changing a focus value of the image based on an obtained image and information on the image;
storing subject information on subjects included in the image; and
superimposing the subject information corresponding to a subject brought into focus based on the changed focus value on the focus-value changed image and displaying the focus-value changed image on which the subject information is superimposed.
